(19) United States
(12) Patent Application Publication
(10) Pub. No.: US 2023/0172346 A1
(43) Pub. Date: Jun. 8, 2023

(54) BEVERAGE CARRYING VEST

(71) Applicant: Trent Landers, Birmingham, AL (US)

(72) Inventor: Trent Landers, Birmingham, AL (US)

(21) Appl. No.: 18/061,119

(22) Filed: Dec. 2, 2022

Related U.S. Application Data
(60) Provisional application No. 63/264,798, filed on Dec. 2, 2021.

(51) Int. Cl. A45F 5/02; A01K 27/00; A01K 13/00

(52) U.S. Cl. CPC A45F 5/02; A01K 27/008; A01K 13/006; A45F 2200/0583

(57) ABSTRACT

An apparatus and method transporting beverage containers by a domesticated animal is disclosed. The beverage carrying vest of the present invention includes a fabric panel that is releasably secured about a torso of the domesticated animal via a neck strap and one or more torso straps. Multiple beverage holders are attached to the fabric panel and disposed in a spaced apart relation along a lateral side of the fabric panel. The beverage holders are dimensioned to receive and retain a cylindrical beverage container.

### CROSS-REFERENCE TO RELATED APPLICATION

This application claims the benefit of priority of U.S. provisional application No. 63/264,798, filed Dec. 2, 2021, the contents of which are herein incorporated by reference.

### BACKGROUND OF THE INVENTION

The present invention relates to beverage carriers, and more particularly to beverage carriers for domesticated animals.

When engaged in outdoor or household activities, it is often desirable for a domesticated animal, such as a pet, to carry a beverage container for either the pet's consumption or the pet owner's consumption.

As can be seen, there is a need for an improved beverage carrying vest.

### SUMMARY OF THE INVENTION

In one aspect of the present invention, a beverage carrying vest is disclosed. The beverage carrying vest includes a fabric panel dimensioned to be supported by a back of a domesticated animal between a withers and a loin and spanning opposed lateral sides of the domesticated animal. A first neck strap and a second neck strap protrude forwardly from the fabric panel and are configured to be aligned with a dorsal plane of the domesticated animal. A first cooperating fastener is provided for adjustably coupling a distal end of the first neck strap and the second neck strap about a chest region of the domesticated animal. One or more torso straps are configured to join each of a left side and a right side of the fabric panel about a brisket region of the domesticated animal. A second cooperating fastener is configured to releasably couple the one or more torso straps to join the left side and the right side of the fabric panel. Multiple beverage holders are disposed in a spaced apart relation on the fabric panel, dimensioned to receive a beverage container.

In some embodiments, an elastic segment is interposed between the one or more torso straps and an attachment with the left side and the right side of the fabric panel.

In some embodiments, the second cooperating fastener includes a hook material applied to a distal end of a first of the one or more torso straps. A pile material is applied to a distal end of the second of the one or more torso straps. The pile material may be disposed in a spaced apart relation and the pile material is disposed in a substantially continuous patch. Alternatively, the hook material is disposed in a spaced apart relation and the pile material is disposed in a substantially continuous patch.

In some embodiments, a U-shaped opening is defined by the first neck strap and the second neck strap. A trough of the U-shaped opening is dimensioned to be positioned about the withers of the domesticated animal. The first neck strap and the second neck strap have a width adapted to avoid an impingement of a shoulder movement of the domesticated animal.

In some embodiments, a posterior edge of the fabric panel converges forwardly to join with the one or more torso straps. The one or more torso straps have a width dimensioned to overlie the brisket of the domesticated animal.

In other aspects of the invention a beverage carrying vest is disclosed. The beverage carrying vest includes a fabric panel adapted to be supported by a back of a domesticated animal, between a withers and a loin, and spanning opposed lateral sides of the domesticated animal. A first neck strap and a second neck strap protrude forwardly from the fabric panel and are adapted to align with a dorsal plane of the domesticated animal. A first cooperating fastener is provided for adjustably coupling the first neck strap and the second neck strap about a chest region of the domesticated animal. A first torso strap and a second torso strap protrude from a lower edge of the fabric panel and are adapted to join each of a left side and a right side of the fabric panel about a brisket region of the domesticated animal. A second cooperating fastener is configured to adjustably couple the first torso strap and the second torso strap to join the left side and the right side of the fabric panel. Multiple beverage holders are disposed in a spaced apart relation on the fabric panel. Each of the beverage holders are dimensioned to receive a beverage container.

These and other features, aspects and advantages of the present invention will become better understood with reference to the following drawings, description and claims.

### BRIEF DESCRIPTION OF THE DRAWINGS

FIG. 1 is a top perspective view of the beverage carrying vest.

FIG. 2 is an exterior, top plan view of the beverage carrying vest.

FIG. 3 is a rear elevation view of the beverage carrying vest.

FIG. 4 is a left side elevation view of the beverage carrying vest.

FIG. 5 is an interior, bottom plan view of the beverage carrying vest.

FIG. 6 is an end elevation view of the beverage carrying vest.

FIG. 7 is a side perspective view of the beverage carrying vest, shown in use worn by a dog, and carrying beverage cans.

FIG. 8 is a detail view of a beverage carrier carrying a beverage can.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide an apparatus and a method for the carriage of beverages by a domesticated animal, such as a dog. The beverage carrying vest may be utilized for outdoors activities, such as hikes and walks in parks. Likewise, the beverage carrying vest may be utilized for household activities, such as parties. Beverages carried by the vest may include liquids for either human or pet consumption.

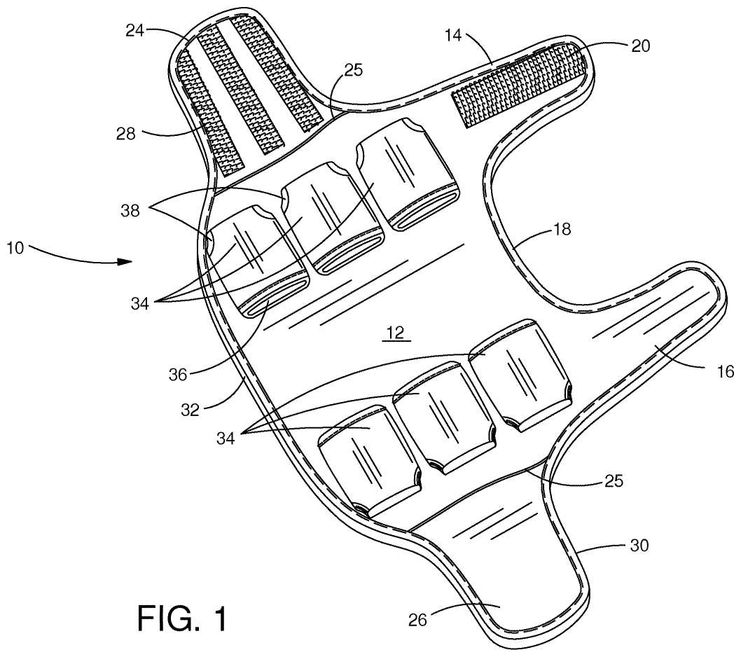

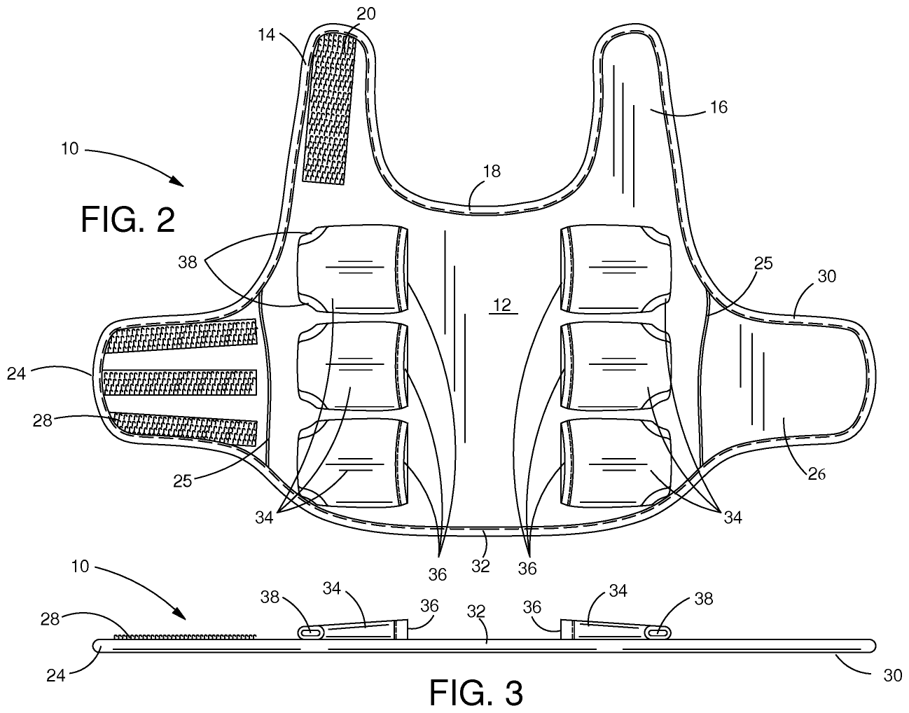

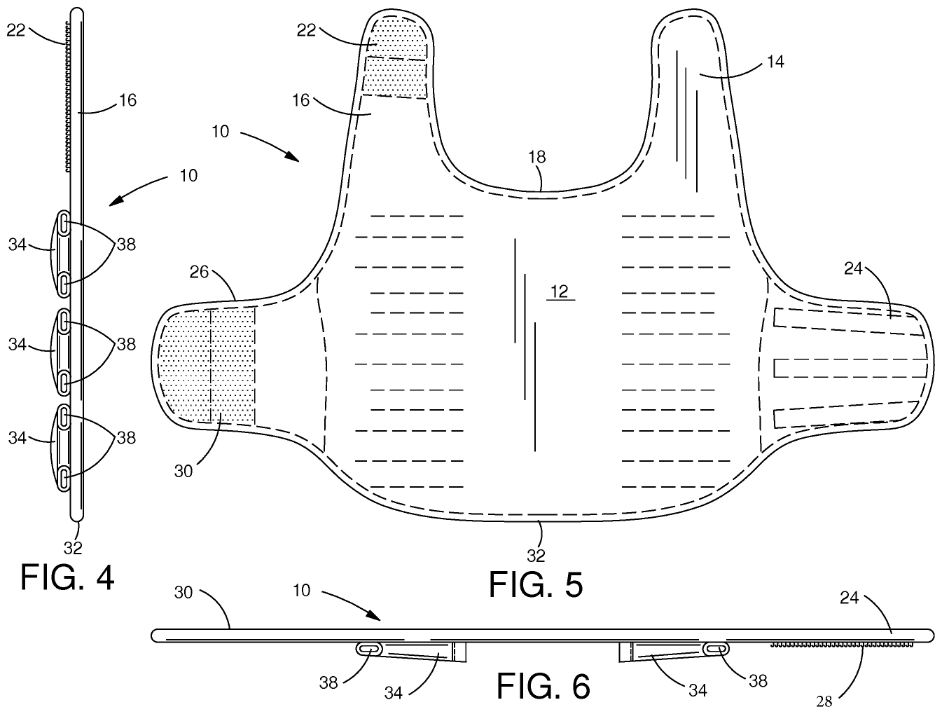

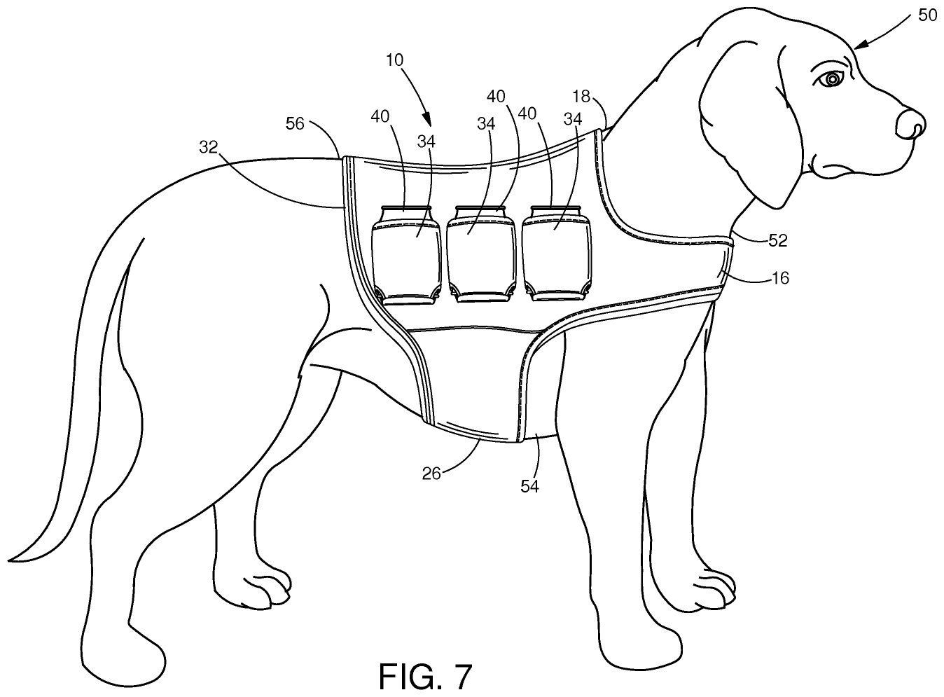

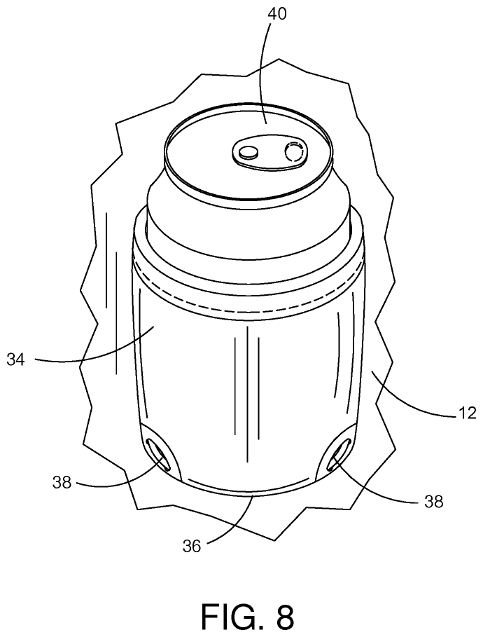

As seen in reference to the drawings of FIGS. 1-7 of the drawings the beverage carrying vest 10 includes a fabric panel 12 having multiple beverage holders 34 affixed to the fabric panel 12. The fabric panel 12 may be selected of a suitable material to accommodate for seasonal variations or changes in weather. For example, in colder seasons the fabric panel 12 may be selected of an insulated material. For warmer seasons, the fabric panel 12 may be selected from a breathable mesh material. The fabric panel 12 may also be selected from a waterproof material to accommodate for precipitation events.

The multiple beverage holders 34 are affixed to opposed lateral sides of the fabric panel 12 and disposed in a spaced apart relation from a front to a back end of the fabric panel 12. The beverage holders 34 have an opening 36 to receive the beverage container 40 and a bottom joined to at least one sidewall of the beverage holder 34. The beverage holders 34 are dimensioned to removably receive one or more of a canned or a bottled beverage container 40. The beverage holders 34 are formed of a resilient insulating material, such as neoprene, or a foam material. One or more bottom openings 38 in the beverage holders 34 facilitate a flattening of the beverage holder 34, when not in use, and an insertion and an extraction of the beverage container 40 from the beverage holder 34.

The beverage holders 34 may be affixed to the fabric panel 12 via a fastener, such as a stitch, an adhesive, a thermal bond, a rivet, and the like. Preferably, the beverage holders 34 are collapsible, such that when empty they present a lower profile and may flatten against the fabric panel 12. Preferably, the beverage holders 34 are affixed to the fabric panel 12 aligned along a dorsal plane of the animal 50 with the opening 36 oriented upright such that the beverage containers 40 are retained in an upright condition along an axial centerline of the beverage container 40.

The fabric panel 12 is dimensioned to be supported by the back of the animal 50 and extends between the withers and the loin along a spinal axis of the animal 50. The fabric panel 12 has a lateral width that extends downwardly from the spinal axis towards the brisket 54 of the animal 50. Preferably, the fabric panel terminates along a line coincident with the belly of the animal, such that the beverage holders 34 are carried and supported by a ribcage of the animal.

A first neck strap 14 and a second neck strap 16 protrude forwardly from the fabric panel 12, defining a U-shaped opening 18. A trough of the U-shaped opening 18 is dimensioned to be positioned proximally to the withers of the animal 50 such that the fabric panel 12 is supported by the back of the animal 50 and does not impinge neck movements of the animal 50. The first neck strap 14 and the second neck strap 16 protrude forwardly from the fabric panel 12 and aligned with a dorsal plane of the animal 50. The first neck strap 14 and the second neck strap 16 have a width such that they avoid impingement or restriction of shoulder movements of the animal 50.

The first neck strap 14 and the second neck strap 16 include a first cooperating fastener 20, 22 affixed with an opposed interior and exterior side of the respective first neck strap 14 and the second neck strap 16. By way of non-limiting example, the first cooperating fastener 20, 22 may include a hook material and a pile, such as Velcro®. The first cooperating fastener 20, 22 may also include hooks and loops, a snap, a buckle, a button, and the like, that may be cooperatively joined to adjustably secure the first neck strap 14 and the second neck strap 16 about the chest 52 of the animal 50 anterior to the forelegs. The positioning of the first cooperating fastener 20, 22 assists in preventing the fabric panel 12 from experiencing rotational displacement about the neck and torso of the domesticated animal 50.

One or more torso straps 24, 26 are connected with a lower anterior portion of the fabric panel 12 to secure a left side 25 and a right side 25 of the fabric panel 12 about the brisket 54 of the animal 50. Preferably, the one or more torso straps 24, 26 include an elastic segment interposed between the one or more torso straps 24, 26 and the attachment with the left side and the right side of the fabric panel 12.

The one or more torso straps 24, 26 include a second cooperating fastener 28, 30 affixed with an opposed interior and exterior side of the respective one or more torso straps 24, 26 or an edge of the fabric panel 12. By way of non-limiting example, the second cooperating fastener 28, 30 may include a hook material and a pile material, such as Velcro®. The second cooperating fastener 28, 30 may also include hooks and loops, a snap, a buckle, a button, and the like, that may be cooperatively joined to adjustably secure the fabric panel 12 about the torso and brisket 54 of the animal 50.

In the non-limiting embodiment shown, an outer, or overlapping, one of the second cooperating fastener 28 is disposed in a spaced apart relation about a distal end of one of the one or more torso straps 24, while an inner or overlapped one of the second cooperating fastener 28 is disposed in a substantially continuous patch at a distal end of the other torso strap 26. The relation of the spaced apart second cooperating fastener 28 allows a user to insert their fingers in the open space between the second cooperating fastener 28 to release the second cooperating fastener 28, 30 without imparting excessive pressure to the animal 50. In like manner, the substantially continuous disposition of the other second cooperating fastener 30 provides an ample target joining space for the spaced apart second cooperating fastener 28 when securing the one or more torso straps 24, 26 about the animal 50.

A posterior edge 32 of the fabric panel 12 converges forwardly along a lateral aspect and a juncture with the one or more torso straps 24, 26, such that one or more torso straps 24, 26 have a longitudinal width to span a majority of the brisket 54 without overlying a belly of the animal 50 and allowing freedom of movement of the forelegs of the animal 50 about the shoulders.

Piping may be applied about a peripheral edge of the fabric panel 12, the first neck strap 14, the second neck strap 16, and the one or more torso straps.

In use, the beverage carrying vest is placed on the domesticated animal with the fabric panel 12 centered along a dorsal centerline of the domesticated animal 50, such that the fabric panel 12 is positioned between the withers and the loin of the animal 50. The first neck strap 14 and the second neck strap 16 are then adjustably secured about the chest of the animal 50 with the one or more torso straps 24, 26 oriented over the brisket of the animal 50. The first cooperating fasteners 20, 22 may then be joined to secure the first neck strap 14 and the second neck strap 16 about the animal 50. The one or more torso straps 24, 26 may then be wrapped about the brisket of the animal 50 and the second cooperating fastener 28, 30 joined to secure the left side 25 with the right side 25 of the fabric panel 12.

Once the beverage carrying vest 10 has been secured to the domesticated animal 50, a beverage container 40 may be inserted into each of the one or more of the beverage holders 34. When inserting multiple beverage containers 40, it is preferable that a weight load of the multiple beverage containers 40 be evenly distributed between a left side and a right side of the beverage carrying vest 10. Once loaded, the domesticated animal 50 can transport the beverage containers 40, for one or more of the outdoors or household activities.

It should be understood, of course, that the foregoing relates to exemplary embodiments of the invention and that modifications may be made without departing from the spirit and scope of the invention as set forth in the following claims.

What is claimed is:

1. A beverage carrying vest, comprising:
a fabric panel dimensioned to be supported by a back of a domesticated animal between a withers and a loin and spanning opposed lateral sides of the domesticated animal;
a first neck strap and a second neck strap protruding forwardly from the fabric panel and configured to be aligned with a dorsal plane of the domesticated animal,
a first cooperating fastener for adjustably coupling a distal end of the first neck strap and the second neck strap about a chest region of the domesticated animal;
one or more torso straps configured to join each of a left side and a right side of the fabric panel about a brisket region of the domesticated animal;
a second cooperating fastener configured to releasably couple the one or more torso straps to join the left side and the right side of the fabric panel; and
multiple beverage holders disposed in a spaced apart relation on the fabric panel, dimensioned to receive a beverage container.

2. The beverage carrying vest of claim 1, further comprising:
an elastic segment interposed between the one or more torso straps and an attachment with the left side and the right side of the fabric panel.

3. The beverage carrying vest of claim 2, the second cooperating fastener further comprising:
a hook material applied to a distal end of a first of the one or more torso straps; and
a pile material applied to a distal end of the second of the one or more torso straps.

4. The beverage carrying vest of claim 3, wherein the pile material is disposed in a spaced apart relation and the pile material is disposed in a substantially continuous patch.

5. The beverage carrying vest of claim 3, wherein the hook material is disposed in a spaced apart relation and the pile material is disposed in a substantially continuous patch.

6. The beverage carrying vest of claim 1,
a U-shaped opening defined by the first neck strap and the second neck strap, wherein a trough of the U-shaped opening is dimensioned to be positioned about the withers of the domesticated animal.

7. The beverage carrying vest of claim 6, wherein the first neck strap and the second neck strap have a width adapted to avoid an impingement of a shoulder movement of the domesticated animal.

8. The beverage carrying vest of claim 7, wherein a posterior edge of the fabric panel converges forwardly to join with the one or more torso straps.

9. The beverage carrying vest of claim 8, wherein the one or more torso straps has a width dimensioned to overlie the brisket of the domesticated animal.

10. A beverage carrying vest, comprising:
a fabric panel adapted to be supported by a back of a domesticated animal, between a withers and a loin, and spanning opposed lateral sides of the domesticated animal;
a first neck strap and a second neck strap protruding forwardly from the fabric panel and adapted to aligned with a dorsal plane of the domesticated animal,
a first cooperating fastener for adjustably coupling the first neck strap and the second neck strap about a chest region of the domesticated animal;
a first torso strap and a second torso strap protruding from a lower edge of the fabric panel adapted to join each of a left side and a right side of the fabric panel about a brisket region of the domesticated animal;
a second cooperating fastener configured to adjustably couple the first torso strap and the second torso strap to join the left side and the right side of the fabric panel; and
multiple beverage holders disposed in a spaced apart relation on the fabric panel, each of the beverage holders dimensioned to receive a beverage container.
